(19) United States
(12) Patent Application Publication
(10) Pub. No.: US 2012/0291002 A1
(43) Pub. Date: Nov. 15, 2012

(54) SYSTEM AND METHOD FOR DESCRIBING SOFTWARE REQUIREMENT LOGIC

(76) Inventors: Paul William Watkinson, Lifton (GB); Alan Stanley Jones, Prague (CZ); Wojtek Rappak, London (GB)

(21) Appl. No.: 13/209,436

(22) Filed: Aug. 14, 2011

Related U.S. Application Data
(60) Provisional application No. 61/484,377, filed on May 10, 2011.

(51) Int. Cl. G06F 9/44

(52) U.S. Cl. 717/100

(57) ABSTRACT

The present invention is a system to describe software requirement logic that includes a plurality of software requirements and an exclusive natural deduction style of formal reasoning that includes a plurality of connectives and a plurality of corresponding Latinate. The connectives include the group consisting of and, if-then, or, or not and the Latinate include the group consisting of conjunction, implication, disjunction or negation. The software requirements are included in a requirement phase and an implementation phase of a traditional software development cycle. The present invention also includes a method for describing software requirement logic.

This application claims priority to U.S. Provisional Application 61/484,377 filed on May 10, 2011, the entire disclosure of which is incorporated by reference.

### TECHNICAL FIELD & BACKGROUND

It is an object of the present invention to provide a system and method to facilitate relatively easier, faster and more accurately defined software requirements through a software tool which ensures that their description is logically correct.

It is an object of the present invention to provide a system and method to capture a logical structure of a plurality of software requirements through a notation which is concerned only with the software requirements' universal format and logical rules.

It is an object of the present invention to provide a system and method for clarification and logical verification of the software requirements at a relative early stage of the development cycle of the software.

What is really needed is a system and method to facilitate relatively easier, faster and more accurately defined software requirements through a software tool which ensures that their description is logically correct, to capture a logical structure of the software requirements through a notation which is concerned only with the software requirements' universal format and logical rules and for clarification and logical verification of the software requirements at an earlier stage in the development cycle of the software.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a flow chart of a traditional software development cycle, in accordance with one embodiment of the present invention.

FIG. 2 illustrates a block diagram of a system for describing logic of a plurality of software requirements, in accordance with one embodiment of the present invention.

FIG. 3 illustrates a flow chart of a method for describing logic of a plurality of software requirements, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

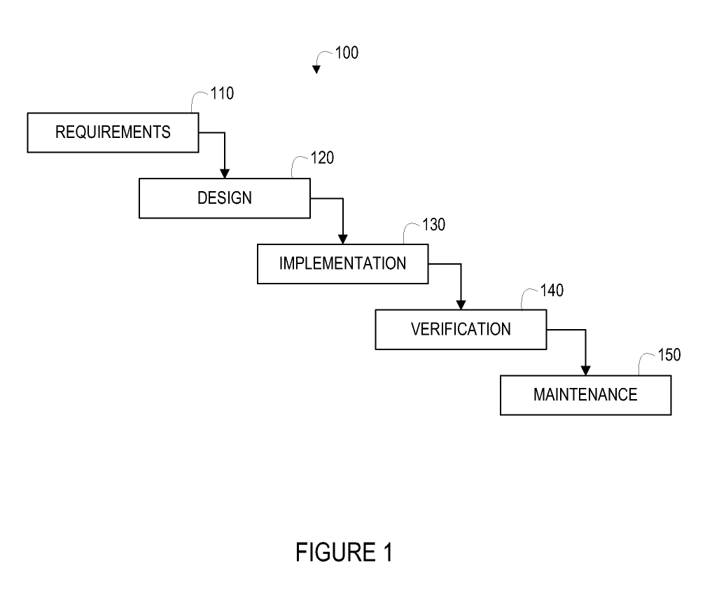

FIG. 1 illustrates a flow chart of a traditional software development cycle 100, in accordance with one embodiment of the present invention. Other software development cycles 100 or portions thereof can include a spiral model, an iterative and incremental development model or an agile development model.

The first phase in the traditional software development cycle 100 is a requirements phase 110. It encompasses those tasks that go into determining the needs or conditions to meet for a new or altered product or result, taking account of the possibly conflicting requirements of the various persons or entities of interest.

The second phase of the traditional software development cycle is a design phase 120, which is to try to identify a software architecture that has a relatively good chance of working or being successful. The software architecture is often defined using free-form diagrams which explore the technical infrastructure and the major entities involved with the software and their relationships. However the software architecture can be defined utilizing other types of suitable diagrams and written expressions as well. The design phase 120 is typically derived in a modeling session, in which issues are explored, until a developing team is satisfied that they understand what final product needs to be delivered.

The third phase of the traditional software development cycle is an implementation phase 130. The implementation phase 130 typically utilizes an evolutionary method that is an iterative and incremental approach to software development. Instead of creating a comprehensive prerequisite such as a requirements specification that is reviewed and accepted before creating a complete design model, the critical development piece evolves over time in an iterative manner. The software is delivered incrementally over time, in small modules that have immediate value, rather than building and then delivering a system in a single relatively highly significant release. By focusing development on relatively smaller modules, agile projects are able to control costs relatively better despite an apparent lack of planning.

The fourth and fifth phases of the traditional software development cycle are a verification phase 140 and a feedback phase 150. The verification phase 140 and software development is test driven. The verification phase 140 and unit testing are achieved from the developer's perspective and the feedback phase 150 and acceptance testing is conducted from the customer's perspective.

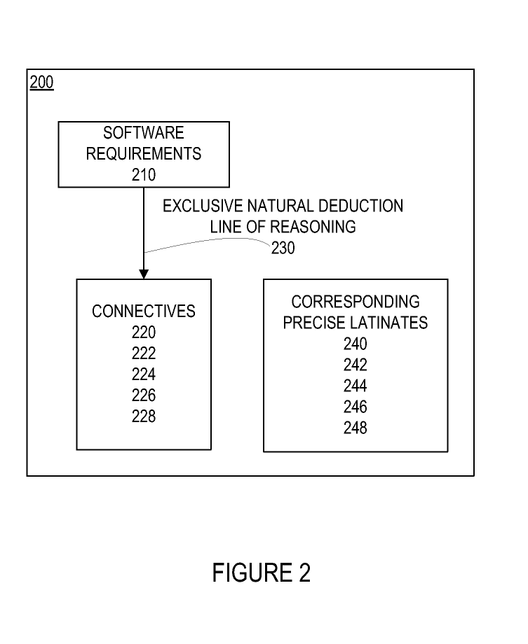

FIG. 2 illustrates a block diagram of a system 200 for describing logic of a plurality of software requirements 210, in accordance with one embodiment of the present invention.

The system 200 includes a plurality of software requirements 210 and four connectives 220. The software requirements 210 are included in the requirements phase 110 and the implementation phase 130 described in FIG. 1 and its description. The system 200 utilizes a natural deduction style of formal reasoning 230 to describe the software requirements 210 so the software requirements 210 are precise and can be interpreted by a human user or a computer in the same way. The natural deduction style of formal reasoning includes four connectives 220 which are an “and” statement 222, an “if-then” statement 224, an “or” statement 226 and a “not” statement 228. The corresponding precise Latinate 240 of the four connectives 220 includes a “conjunction” statement 242, an “implication” statement 244, a “disjunction” statement 246 and a “negation” statement 248. The natural deduction style of formal reasoning is exclusive and the system 200 will only utilize the natural deduction style of formal reasoning. The system 200 provides a tighter link between a logically correct requirement description that can be understood by a human and a specification that can be transformed into a computer process.

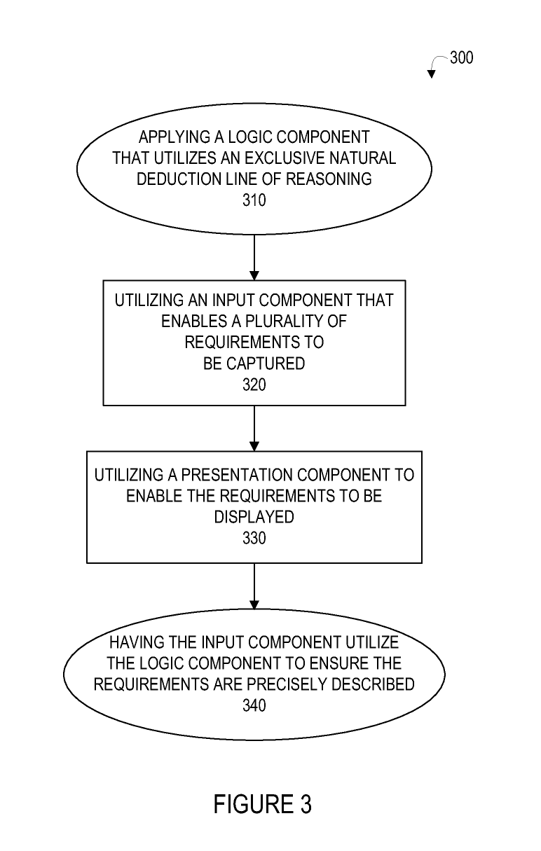

FIG. 3 illustrates a flow chart of a method 300 for describing logic of a plurality of software requirements, in accordance with one embodiment of the present invention.

The method 300 includes the steps of applying a logic component that utilizes a natural deduction line of reasoning 310, utilizing an input component that enables a plurality of requirements to be captured 320, utilizing a presentation component to enable the requirements to be displayed 330 and having the input component utilize the logic component to ensure that the requirements are precisely described 340.

The method 300 for describing the logic of a plurality of software requirements by applying a natural deduction line of reasoning for the capture of the software requirements ensures that the user can exclusively describe the software requirements in terms of the natural deduction line of reasoning. The natural deduction style of formal reasoning is exclusive and the system 300 will only utilize the natural deduction style of formal reasoning. Once this logical statement has been captured it can then be displayed in a number of formats that include text formatters, Z model based notation computer platforms, unified modeling language or UML, C general purpose computer programming language and Java programming language.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to describe software requirement logic, comprising:
a plurality of software requirements; and
an exclusive natural deduction style of formal reasoning that includes a plurality of connectives; and
a logical statement reflecting said requirements in said exclusive natural deduction line of formal reasoning.

2. The system according to claim 1, wherein said software requirements are included in a requirement phase and an implementation phase of a traditional software development cycle.

3. The system according to claim 1, wherein said connective is an and statement or an if-then statement.

4. The system according to claim 1, wherein said connective is an or statement.

5. The system according to claim 1, wherein said connective is a not statement.

6. The system according to claim 1, wherein said logical statement is displayed in a format selected from the group consisting of a plurality of text formatters, a Z model based notation computer platform, a unified computer programming language or a JAVA programming language.

7. A system to describe software requirement logic, comprising:
a plurality of software requirements; and
an exclusive natural deduction style of formal reasoning that includes a plurality of connectives and a plurality of corresponding Latinate; and
a logical statement reflecting said requirements in said exclusive natural deduction line of formal reasoning.

8. The system according to claim 7, wherein said software requirements are included in a requirement phase and an implementation phase of a traditional software development cycle.

9. The system according to claim 7, wherein said connective is an and statement or an if-then statement.

10. The system according to claim 7, wherein said connective is an or statement.

11. The system according to claim 7, wherein said connective is a not statement.

12. The system according to claim 7, wherein said corresponding Latinate is conjunction.

13. The system according to claim 7, wherein said corresponding Latinate is implication.

14. The system according to claim 7, wherein said corresponding Latinate is disjunction.

15. The system according to claim 7, wherein said corresponding Latinate is negation.

16. The system according to claim 7, wherein said logical statement is displayed in a format selected from the group consisting of a plurality of text formatters, a Z model based notation computer platform, a unified computer programming language or a JAVA programming language.

17. A method for describing software requirement logic, comprising:
applying a logic component that utilizes an exclusive natural deduction line of formal reasoning;
utilizing an input component that enables a plurality of requirements to be captured;
utilizing a presentation component to enable said requirements to be displayed;
having said input component utilize said logic component to ensure that said requirements are precisely described; and
capturing a logical statement reflecting said requirement in said exclusive natural deduction line of formal reasoning.

18. The method according to claim 17, wherein said exclusive natural deduction line of formal reasoning includes a plurality of connectives and a plurality of corresponding Latinate.

19. The method according to claim 18, wherein said connectives are selected from the group consisting of and, if-then, or, or not and said corresponding Latinate are selected from the group consisting of conjunction, implication, disjunction or negation.

20. The method according to claim 18, wherein said logical statement is displayed in a format selected from the group consisting of a plurality of text formatters, a Z model based notation computer platform, a unified computer programming language or a JAVA programming language.
